(19) United States
(12) Patent Application Publication
(10) Pub. No.: US 2023/0033180 A1
(43) Pub. Date: Feb. 2, 2023

(54) NONAQUEOUS ELECTROLYTE ENERGY STORAGE DEVICE AND METHOD FOR MANUFACTURING THE SAME

(71) Applicant: GS YUASA INTERNATIONAL LTD., Kyoto-shi, Kyoto (KR)

(72) Inventor: Jinya UEDA, Kyoto-shi, Kyoto (JP)

(21) Appl. No.: 17/787,469

(22) PCT Filed: Dec. 15, 2020
(86) PCT No.: PCT/JP2020/046699

§ 371 Date: Jun. 20, 2022

(30) Foreign Application Priority Data
Dec. 23, 2019 (JP) 2019-231912

(51) Int. Cl. H01M 50/489; H01M 50/446; H01M 10/0525

(52) U.S. Cl. CPC H01M 50/489; H01M 50/446; H01M 10/0525; H01M 2004/027

(57) ABSTRACT

An aspect of the present invention is a nonaqueous electrolyte energy storage device including a negative electrode containing metal lithium, a nonaqueous electrolyte including a fluorinated solvent, and a separator with an air permeability resistance of 150 seconds or less.

### TECHNICAL FIELD

The present invention relates to a nonaqueous electrolyte energy storage device and a method for manufacturing the same.

### BACKGROUND ART

Nonaqueous electrolyte secondary batteries typified by lithium ion secondary batteries are widely used for electronic devices such as personal computers and communication terminals, motor vehicles, and the like since these secondary batteries have a high energy density. The nonaqueous electrolyte secondary batteries generally include a pair of electrodes, which are electrically separated from each other by a separator, and a nonaqueous electrolyte interposed between the electrodes, and are configured to allow ions to be transferred between the two electrodes for charge-discharge. Capacitors such as lithium ion capacitors and electric double-layer capacitors are also widely used as nonaqueous electrolyte energy storage devices other than nonaqueous electrolyte secondary batteries. Metal lithium is known as a negative active material with a high energy density for use in nonaqueous electrolyte energy storage devices (see Patent Documents 1 and 2).

### PRIOR ART DOCUMENTS

### Patent Documents

Patent Document 1: JP-A-2016-100065

Patent Document 2: JP-A-07-245099

### SUMMARY OF THE INVENTION

### Problems to be Solved by the Invention

In a nonaqueous electrolyte energy storage device in which metal lithium is used for a negative active material, metal lithium may be precipitated in a dendritic form at the surface of the negative electrode during charge (hereinafter, metal lithium in a dendritic form is referred to as a “dendrite”). When the dendrite grows, penetrates a separator, and then comes into contact with a positive electrode, a short circuit is caused. For this reason, a nonaqueous electrolyte energy storage device including metal lithium as a negative active material has the disadvantage that a short circuit is likely to be caused by repeating charge-discharge.

The present invention has been made in view of the circumstances as described above, and an object of the present invention is to provide a nonaqueous electrolyte energy storage device in which any short circuit is suppressed, and a method for manufacturing such a nonaqueous electrolyte energy storage device.

### Means for Solving the Problems

An aspect of the present invention is a nonaqueous electrolyte energy storage device including a negative electrode containing metal lithium, a nonaqueous electrolyte including a fluorinated solvent, and a separator with an air permeability resistance of 150 seconds or less.

Another aspect of the present invention is a method for manufacturing a nonaqueous electrolyte energy storage device, including: preparing a negative electrode containing metal lithium; preparing a nonaqueous electrolyte including a fluorinated solvent; and preparing a separator with an air permeability resistance of 150 seconds or less.

### Advantages of the Invention

According to an aspect of the present invention, it is possible to provide a nonaqueous electrolyte energy storage device in which any short circuit is suppressed, and a method for manufacturing such a nonaqueous electrolyte energy storage device.

### BRIEF DESCRIPTION OF THE DRAWINGS

FIG. 1 is an external perspective view showing a nonaqueous electrolyte energy storage device according to one embodiment of the present invention.

FIG. 2 is a schematic diagram showing an energy storage apparatus including a plurality of the nonaqueous electrolyte energy storage devices according to an embodiment of the present invention.

### MODE FOR CARRYING OUT THE INVENTION

First, outlines of a nonaqueous electrolyte energy storage device and a method for manufacturing the nonaqueous electrolyte energy storage device disclosed by the present specification will be described.

A nonaqueous electrolyte energy storage device according to an aspect of the present invention is a nonaqueous electrolyte energy storage device including a negative electrode containing metal lithium, a nonaqueous electrolyte including a fluorinated solvent, and a separator with an air permeability resistance of 150 seconds or less.

In the nonaqueous electrolyte energy storage device, any short circuit is suppressed. Although the reason therefor is not clear, the following reason is presumed. The use of the separator with the low air permeability resistance homogenizes the concentration distribution of lithium ions in the nonaqueous electrolyte in the vicinity of the negative electrode surface, thereby inhibiting the precipitation and growth of dendrites. In addition, the film formed on the negative electrode surface from the nonaqueous electrolyte including the fluorinated solvent inhibits precipitation and growth of dendrites. Accordingly, the use of the nonaqueous electrolyte including the fluorinated solvent and the separator with the air permeability resistance of 150 seconds or less is presumed to inhibit the growth of dendrites, thereby suppressing any short circuit. In addition, the nonaqueous electrolyte energy storage device has any short circuit suppressed, and thus also has a high capacity retention ratio in a charge-discharge cycle.

In this regard, the “air permeability resistance” is a value measured by a “Gurley tester method” in accordance with JIS-P 8117 (2009). The test piece of the separator used for the measurement has dimensions of 50 mm×50 mm.

It is to be noted that the air permeability resistance of the separator provided in the nonaqueous electrolyte energy storage device is measured with the use of the separator obtained from the nonaqueous electrolyte energy storage device disassembled by the following method. First, the nonaqueous electrolyte energy storage device is discharged, and then the nonaqueous electrolyte energy storage device is disassembled under a dry atmosphere. Next, the separator is taken out, washed with a hydrochloric acid of 36% by mass in concentration, further washed with deionized water, and then subjected to vacuum drying at normal temperature for 10 hours or longer. Thereafter, the separator subjected to the vacuum drying is cut out to obtain a test piece.

It is to be noted that the negative electrode provided in the nonaqueous electrolyte energy storage device has only to contain metal lithium at least in a charged state, and in a discharged state, may contain metal lithium or contain no metal lithium. For example, the nonaqueous electrolyte energy storage device may be configured such that metal lithium is precipitated in at least a partial region of the negative electrode surface in the charged state, the metal lithium at the negative electrode surface is substantially all eluted into the nonaqueous electrolyte by discharging the device, and thus, metal lithium is substantially absent at the negative electrode surface in the discharged state.

The air permeation resistance is preferably 50 seconds or more and 80 seconds or less. The use of the separator with such an air permeability resistance further keeps the nonaqueous electrolyte energy storage device from being short-circuited.

The separator preferably has a substrate resin and inorganic particles dispersed in the substrate resin. The use of such a separator further keeps the nonaqueous electrolyte energy storage device from being short-circuited. Although the reason why such an effect is produced is not clear, some reasons are presumed, such as the fact that the presence of the inorganic particles provides the separator in a suitable porous shape, and the fact that the presence of the inorganic particles increases the strength of the separator, thereby allowing the suitable porous shape to be maintained even with the separator pressurized, with favorable high permeability kept.

The positive electrode potential at the end-of-charge voltage under normal usage in the nonaqueous electrolyte energy storage device is preferably 4.30 V vs. Li/Li⁺ or higher. The positive electrode potential at the end-of-charge voltage under normal usage is set to be equal to or more than the above lower limit, thereby allowing the discharge capacity to be increased, and allowing the energy density to be increased. In addition, in the case of repeating charge-discharge to a high potential such that the positive electrode potential reaches 4.30 V vs. Li/Li⁺ or higher, the amount of electricity used in the positive electrode for decomposition of a component with low oxidation resistance in the nonaqueous electrolyte is believed to be, for example, used for precipitation and growth of dendrites in the negative electrode, thereby making a short circuit more likely to be caused. Thus, it is possible to sufficiently enjoy the advantages of the present invention for resolving such disadvantages.

A method for manufacturing a nonaqueous electrolyte energy storage device according to an aspect of the present invention is a method for manufacturing a nonaqueous electrolyte energy storage device, including: preparing a combination of a positive electrode with a negative electrode containing metal lithium or a negative electrode that has a surface region capable of precipitating metal lithium during charge; preparing a nonaqueous electrolyte including a fluorinated solvent; and preparing a separator with an air permeability resistance of 150 seconds or less.

The manufacturing method is capable of manufacturing a nonaqueous electrolyte energy storage device in which any short circuit is suppressed.

Hereinafter, the nonaqueous electrolyte energy storage device according to an embodiment of the present invention and the method for manufacturing the nonaqueous electrolyte energy storage device will be described in order.

### Nonaqueous Electrolyte Energy Storage Device

The nonaqueous electrolyte energy storage device according to an embodiment of the present invention has a positive electrode, a negative electrode, and a nonaqueous electrolyte. Hereinafter, a nonaqueous electrolyte secondary battery (hereinafter, also simply referred to as a “secondary battery”) will be described as an example of the nonaqueous electrolyte energy storage device. The positive electrode and the negative electrode usually form an electrode assembly in which the positive electrode and the negative electrode are alternately superposed by being stacked or wound with a separator interposed therebetween. The electrode assembly is housed in a case, and the case is filled with the nonaqueous electrolyte. The nonaqueous electrolyte is interposed between the positive electrode and the negative electrode. As the case, a known metal case, a resin case or the like, which is usually used as a case of a secondary battery, can be used.

### Positive Electrode

The positive electrode has a positive substrate and a positive active material layer disposed directly or via an intermediate layer on the positive substrate.

The positive substrate has conductivity. Having “conductivity” means having a volume resistivity of 10⁷ Ω·cm or less that is measured in accordance with JIS-H-0505 (1975), and the term “non-conductivity” means that the volume resistivity is more than 10⁷ Ω·cm. As the material of the positive substrate, a metal such as aluminum, titanium, tantalum, stainless steel, or an alloy thereof is used. Among these, aluminum and aluminum alloys are preferable from the viewpoint of the balance of electric potential resistance, high conductivity, and cost. Example of the form of formation of the positive substrate include a foil and a vapor deposition film, and a foil is preferred from the viewpoint of cost. More specifically, an aluminum foil is preferable as the positive substrate. Examples of aluminum and the aluminum alloy include A1085P and A3003P specified in JIS-H-4000 (2014).

The average thickness of the positive substrate is preferably 3 μm or more and 50 μm or less, more preferably 5 μm or more and 40 μm or less, still more preferably 8 μm or more and 30 μm or less, and particularly preferably 10 μm or more and 25 μm or less. When the average thickness of the positive substrate is within the above-described range, it is possible to enhance the energy density per volume of a secondary battery while increasing the strength of the positive substrate. The “average thickness” refers to a value obtained by dividing the cutout mass in cutout of a substrate having a predetermined area by the true density and cutout area of the substrate. Hereinafter, the same applies to the “average thicknesses” of the negative substrate and negative active material layer described later.

The intermediate layer is a coating layer on the surface of the positive substrate, and contains conductive particles such as carbon particles to reduce contact resistance between the positive substrate and the positive active material layer. The configuration of the intermediate layer is not particularly limited, and the intermediate layer can be formed of, for example, a composition containing a resin binder and conductive particles.

The positive active material layer is formed of a so-called positive composite containing a positive active material. The positive composite forming the positive active material layer may contain optional components such as a conductive agent, a binder, a thickener, and a filler and the like as necessary.

The positive active material can be appropriately selected from known positive active materials. As the positive active material for a lithium ion secondary battery, a material capable of storing and releasing lithium ions is usually used. Examples of the positive active material include lithium-transition metal composite oxides having an α-NaFeO₂-type crystal structure, lithium-transition metal oxides having a spinel-type crystal structure, polyanion compounds, chalcogenides, and sulfur. Examples of the lithium transition metal composite oxide having an α-NaFeO₂ type crystal structure include Li[LiₓNi₁₋ₓ]O₂ (0≤x<0.5), Li[LiₓNi_{γ}Co_{1-x-γ}]O₂ (0≤x<0.5, 0<γ<1), Li[LiₓCo₁₋ₓ]O₂ (0≤x<0.5), Li[LiₓNi_{γ}Mn_{1-x-γ}]O₂ (0≤x<0.5, 0<γ<1), Li[LiₓNi_{γ}Mn_{β}Co_{1-x-γ-β}]O₂ (0≤x<0.5, 0<γ, 0<β, 0.5<γ+β<1), and Li[LiₓNi_{γ}Co_{β}Al_{1-x-γ-β}]O₂ (0≤x<0.5, 0<γ, 0<β, 0.5<γ+β<1). Examples of the lithium-transition metal composite oxides having a spinel-type crystal structure include LiₓMn₂O₄ and LiₓNi_{γ}Mn_{2-γ}O₄, Examples of the polyanion compounds include LiFePO₄, LiMnPO₄, LiNiPO₄, LiCoPO₄, Li₃V₂(PO₄)₃, Li₂MnSiO₄, and Li₂CoPO₄F. Examples of the chalcogenides include titanium disulfide, molybdenum disulfide, and molybdenum dioxide. A part of atoms or polyanions in these materials may be substituted with atoms or anion species composed of other elements. The surfaces of these materials may be coated with other materials. In the positive active material layer, one of these materials may be used singly, or two or more thereof may be used in mixture.

The average particle size of the positive active material is preferably 0.1 μm or more and 20 μm or less, for example. By setting the average particle size of the positive active material to be equal to or greater than the above lower limit, the positive active material is easily manufactured or handled. By setting the average particle size of the positive active material to be equal to or less than the above upper limit, the electron conductivity of the positive active material layer is improved. Here, the term “average particle size” means a value at which a volume-based integrated distribution calculated in accordance with JIS-Z-8819-2 (2001) is 50% based on a particle size distribution measured by a laser diffraction/scattering method for a diluted solution obtained by diluting particles with a solvent in accordance with JIS-Z-8825 (2013).

A crusher, a classifier, or the like is used to obtain particles of the positive active material in a predetermined shape. Examples of a crushing method include a method in which a mortar, a ball mill, a sand mill, a vibratory ball mill, a planetary ball mill, a jet mill, a counter jet mill, a whirling airflow type jet mill, or a sieve or the like is used. At the time of crushing, wet type crushing in the presence of water or an organic solvent such as hexane can also be used. As a classification method, a sieve or a wind force classifier or the like is used based on the necessity both in dry manner and in wet manner.

The content of the positive active material in the positive active material layer is preferably 70% by mass or more and 98% by mass or less, more preferably 80% by mass or more and 97% by mass or less, further preferably 90% by mass or more and 96% by mass or less. The content of the positive active material particles within the range mentioned above allows an increase in the electric capacity of the secondary battery.

The conductive agent is not particularly limited so long as it is a material having conductivity. Examples of such a conductive agent include carbonaceous materials; metals; and conductive ceramics. Examples of carbonaceous materials include graphite and carbon black. Examples of the type of the carbon black include furnace black, acetylene black, and ketjen black. Among these, carbonaceous materials are preferable from the viewpoint of conductivity and coatability. In particular, acetylene black and ketjen black are preferable. Examples of the shape of the conductive agent include a powder shape, a sheet shape, and a fibrous shape.

The content of the conductive agent in the positive active material layer is preferably 1% by mass or more and 40% by mass or less, more preferably 2% by mass or more and 10% by mass or less. By setting the content of the conductive agent in the above range, the energy density of the secondary battery can be enhanced.

Examples of the binder include: thermoplastic resins such as fluororesin (polytetrafluoroethylene (PTFE), polyvinylidene fluoride (PVDF), etc.), polyethylene, polypropylene, and polyimide; elastomers such as ethylene-propylene-diene rubber (EPDM), sulfonated EPDM, styrene-butadiene rubber (SBR), and fluororubber; and polysaccharide polymers.

The content of the binder in the positive active material layer is preferably 0.5% by mass or more and 10% by mass or less, more preferably 1% by mass or more and 6% by mass or less. When the content of the binder is in the above range, the active material can be stably held.

Examples of the thickener include polysaccharide polymers such as carboxymethylcellulose (CMC) and methylcellulose. When the thickener has a functional group that reacts with lithium, it is preferable to deactivate this functional group by methylation and the like in advance. According to an aspect of the present invention, the thickener is preferably not contained in the positive active material layer in some cases.

The filler is not particularly limited. Examples of the filler include polyolefins such as polypropylene and polyethylene, inorganic oxides such as silicon dioxide, aluminum oxide, titanium dioxide, calcium oxide, strontium oxide, barium oxide, magnesium oxide and aluminosilicate, hydroxides such as magnesium hydroxide, calcium hydroxide and aluminum hydroxide, carbonates such as calcium carbonate, hardly soluble ionic crystals of calcium fluoride, barium fluoride, barium sulfate and the like, nitrides such as aluminum nitride and silicon nitride, and substances derived from mineral resources, such as talc, montmorillonite, boehmite, zeolite, apatite, kaolin, mullite, spinel, olivine, sericite, bentonite and mica, and artificial products thereof. According to an aspect of the present invention, the filler is preferably not contained in the positive active material layer in some cases.

The positive active material layer may contain a typical nonmetal element such as B, N, P, F, Cl, Br, or I, a typical metal element such as Li, Na, Mg, Al, K, Ca, Zn, Ga, Ge, Sn, Sr, and Ba or a transition metal element such as Sc, Ti, V, Cr, Mn, Fe, Co, Ni, Cu, Mo, Zr, Nb, or W as a component other than the positive active material, the conductive agent, the binder, the thickener, and the filler.

### Negative Electrode

The negative electrode has a negative substrate and a negative active material layer disposed directly or via an intermediate layer on the negative substrate. The intermediate layer of the negative electrode may have the same configuration as the intermediate layer of the positive electrode.

Although the negative substrate may have the same configuration as that of the positive substrate, as the material, metals such as copper, nickel, stainless steel, and nickel-plated steel or alloys thereof are used, and copper or a copper alloy is preferable. More specifically, the negative substrate is preferably a copper foil. Examples of the copper foil include a rolled copper foil and an electrolytic copper foil.

The average thickness of the negative substrate is preferably 2 μm or more and 35 μm or less, more preferably 3 μm or more and 30 μm or less, still more preferably 4 μm or more and 25 μm or less, particularly preferably 5 μm or more and 20 μm or less. When the average thickness of the negative substrate is within the above-described range, it is possible to enhance the energy density per volume of a secondary battery while increasing the strength of the negative substrate.

The negative active material layer has metal lithium. The metal lithium is a component that functions as a negative active material. The metal lithium may be present as pure metal lithium substantially composed of only lithium, or may be present as a lithium alloy containing other metal components. Examples of the lithium alloy include a lithium silver alloy, a lithium zinc alloy, a lithium calcium alloy, a lithium aluminum alloy, a lithium magnesium alloy, and a lithium indium alloy. The lithium alloy may contain multiple metal elements other than lithium.

The negative active material layer may be a layer composed substantially of only metal lithium. The content of lithium in the negative active material layer may be 90% by mass or more, may be 99% by mass or more, and may be 100% by mass.

The negative active material layer may be a lithium foil or a lithium alloy foil. The negative active material layer may be a non-porous layer (solid layer). In addition, the negative active material layer may be a porous layer including particles containing metal lithium. The negative active material layer, which is a porous layer including particles containing metal lithium, may further have, for example, resin particles, inorganic particles, and the like. The average thickness of the negative active material layer is preferably 5 μm or more and 1,000 μm or less, more preferably 10 μm or more and 500 μm or less, still more preferably 30 μm or more and 300 μm or less.

It is to be noted that in the case of a nonaqueous electrolyte energy storage device such that metal lithium is precipitated on at least a part of the negative electrode surface in a charged state, the metal lithium at the negative electrode surface is substantially all eluted into the nonaqueous electrolyte by discharging the device, the negative electrode may have no negative active material layer in a discharged state.

### Separator

The separator is not particularly limited as long as the separator has an air permeability resistance of 150 seconds or less, and can be appropriately selected from known separators. As the separator, for example, a separator composed of only a substrate layer, a separator in which a heat resistant layer containing heat resistant particles and a binder is formed on one surface or both surfaces of the substrate layer, or the like can be used. From the viewpoint of further suppressing short circuits, a separator composed of only s substrate layer may be preferable.

Examples of the form of the substrate layer of the separator include a woven fabric, a nonwoven fabric, and a porous resin film, and a porous resin film is preferable. The material of the substrate layer of the separator is typically a resin. As the resin (substrate resin) for the material of the substrate layer of the separator, a polyolefin such as polyethylene or polypropylene is preferable from the viewpoint of a shutdown function, and polyimide, aramid or the like is preferable from the viewpoint of resistance to oxidation and decomposition. As the substrate layer of the separator, a material obtained by combining these resins may be used.

The separator preferably has a substrate resin and inorganic particles dispersed in the substrate resin. The use of the separator with the inorganic particles dispersed in the substrate resin further keeps the nonaqueous electrolyte energy storage device from being short-circuited. For the separator including the substrate resin and the inorganic particles dispersed in the substrate resin, the substrate layer is typically formed from the substrate resin and the inorganic particles. In this case, the separator is more preferably a separator composed of only the substrate layer, that is, a separator without any other layer such as a heat-resistant layer. It is to be noted that the substrate layer of the separator contains therein the inorganic particles dispersed, thereby allowing the separator to have favorable heat resistance even in the absence of any heat-resistant layer. The substrate layer may further contain therein components other than the substrate resin and the inorganic particles.

Examples of the specific type of the substrate resin include the resins described above as a material for the substrate layer of the separator.

Examples of the specific type for the material constituting the inorganic particles include oxides such as iron oxide, silicon oxide, aluminum oxide, titanium dioxide, barium titanate, zirconium oxide, calcium oxide, strontium oxide, barium oxide, magnesium oxide and aluminosilicate; hydroxides such as magnesium hydroxide, calcium hydroxide and aluminum hydroxide; nitrides such as aluminum nitride and silicon nitride; carbonates such as calcium carbonate; sulfates such as barium sulfate; hardly soluble ionic crystals of calcium fluoride, barium fluoride, and the like; covalently bonded crystals such as silicon and diamond; and substances derived from mineral resources, such as talc, montmorillonite, boehmite, zeolite, apatite, kaolin, mullite, spinel, olivine, sericite, bentonite and mica, and artificial products thereof. As the inorganic compound, a simple substance or a complex of these substances may be used alone, or two or more thereof may be mixed and used. Among these inorganic compounds, silicon oxide, aluminum oxide, or aluminosilicate is preferable from the viewpoint of safety of the nonaqueous electrolyte energy storage device.

The content of the inorganic particles in the substrate layer is preferably 1% by mass or more and 70% by mass or less, more preferably 5% by mass or more and 50% by mass or less, still more preferably 10% by mass or more and 20% by mass or less. The content of the inorganic particles within the range mentioned above further keeps the nonaqueous electrolyte energy storage device from being short-circuited. In addition, the content of the inorganic particles within the range mentioned above achieves a suitable balance between the strength (the pressure resistance in the thickness direction) and the flexibility, tear resistance, or the like.

The heat resistant particles included in the heat resistant layer preferably have a mass loss of 5% or less in the case of heating from room temperature to 500° C. under the atmosphere, and more preferably have a mass loss of 5% or less in the case of heating from room temperature to 800° C. under the atmosphere. Inorganic compounds can be mentioned as materials whose mass loss is less than or equal to a predetermined value when the materials are heated. Examples of the inorganic compounds include the compounds described above as the material constituting the inorganic particles in the substrate layer. Among the inorganic compounds, silicon oxide, aluminum oxide, or aluminosilicate is preferable from the viewpoint of safety of the nonaqueous electrolyte energy storage device.

The air permeability resistance of the separator is preferably 30 seconds or more and 150 seconds or less, more preferably 35 seconds or more and 100 seconds or less, still more preferably 50 seconds or more and 80 seconds or less. The use of the separator with the air permeability resistance within the range mentioned above further keeps the nonaqueous electrolyte energy storage device from being short-circuited. The air permeability resistance of the separator is adjusted with the porosity, average thickness, and the like of the separator. In addition, as the separator with such an air permeability resistance, a commercially available product can be used.

The average thickness of the separator is, for example, preferably 3 μm or more and 50 μm or less, more preferably 10 μm or more and 25 μm or less. The average thickness of the separator is equal to or more than the above lower limit, thereby allowing any short circuit to be further suppressed. In contrast, the average thickness of the separator is equal to or less than the above upper limit, thereby allowing for an increase in the energy density of the nonaqueous electrolyte energy storage device. It is to be noted that the average thickness of the separator is regarded as an average value of thicknesses measured at any ten points.

### Nonaqueous Electrolyte

The nonaqueous electrolyte includes a fluorinated solvent. The nonaqueous electrolyte may be a nonaqueous electrolyte solution that includes: a nonaqueous solvent including a fluorinated solvent; and an electrolyte salt dissolved in the nonaqueous solvent.

The fluorinated solvent is a solvent that has a fluorine atom. The fluorinated solvent may be a solvent in which some or all of hydrogen atoms in a hydrocarbon group in a nonaqueous solvent having the hydrocarbon group are substituted with fluorine atoms. The nonaqueous electrolyte includes the fluorinated solvent, thereby suppressing any short circuit. In addition, the use of the fluorinated solvent enhances the oxidation resistance, and allows favorable charge-discharge cycle performance to be maintained even in the case of charge in which the positive electrode potential during normal usage reaches a high potential. Examples of the fluorinated solvent include fluorinated carbonates, fluorinated carboxylic acid esters, fluorinated phosphoric acid esters, and fluorinated ethers. One of the fluorinated solvents, or two or more thereof can be used.

Among fluorinated solvents, fluorinated carbonates are preferable, and fluorinated cyclic carbonates and fluorinated chain carbonates are more preferably used in combination. The use of the cyclic carbonate allows the dissociation of the electrolyte salt to be promoted to improve the ionic conductivity of the nonaqueous electrolyte. The use of the fluorinated chain carbonate allows the viscosity of the nonaqueous electrolyte to be kept low. When the fluorinated cyclic carbonate and the fluorinated chain carbonate are used in combination, the volume ratio of the fluorinated cyclic carbonate to the fluorinated chain carbonate (fluorinated cyclic carbonate:fluorinated chain carbonate) is preferably in a range from 5:95 to 50:50, for example.

The lower limit of the content ratio of the fluorinated carbonate in the fluorinated solvent is preferably 50% by volume, more preferably 70% by volume, still more preferably 90% by volume. The upper limit of the content ratio of the fluorinated carbonate in the fluorinated solvent may be 100% by volume.

Examples of the fluorinated cyclic carbonate include fluorinated ethylene carbonates such as fluoroethylene carbonate (FEC) and difluoroethylene carbonate, fluorinated propylene carbonates, and fluorinated butylene carbonates. Among these carbonates, fluorinated ethylene carbonates are preferable, and FEC is more preferable. The FEC exhibits high oxidation resistance and has a high effect of suppressing side reactions (oxidative decomposition of nonaqueous solvent and the like) that may occur at the time of charge-discharge of the secondary battery.

Examples of the fluorinated chain carbonates include a trifluoromethyl ethyl carbonate, a trifluoroethyl methyl carbonate, a bis(trifluoromethyl)carbonate, and a bis(trifluoroethyl)carbonate.

Examples of the fluorinated carboxylic acid ester include methyl 3,3,3-trifluoropropionate and 2,2,2-trifluoroethyl acetate.

Examples of the fluorinated phosphoric acid ester include tris(2,2-difluoroethyl) phosphate and tris(2,2,2-trifluoroethyl) phosphate.

Examples of the fluorinated ether include 1,1,2,2-tetrafluoroethyl-2,2,2-trifluoroethyl ether, methylheptafluoropropyl ether, and methylnonafluorobutyl ether.

The nonaqueous solvent may contain a nonaqueous solvent other than the fluorinated solvent. Examples of such a nonaqueous solvent include carbonates other than the fluorinated solvent, carboxylic acid esters, phosphoric acid esters, and ethers.

The lower limit of the content ratio of the fluorinated solvent to the total nonaqueous solvent is preferably 50% by volume, more preferably 70% by volume, still more preferably 90% by volume. The content ratio of the fluorinated solvent in the nonaqueous solvent is increased, thereby allowing the short circuit suppression, the oxidation resistance, and the like to be further enhanced.

The electrolyte salt can be appropriately selected from known electrolyte salts. Examples of the electrolyte salt include a lithium salt, a sodium salt, a potassium salt, a magnesium salt, and an onium salt. Among them, the lithium salt is preferable.

Examples of the lithium salt include inorganic lithium salts such as LiPF₆, LiPO₂F₂, LiBF₄, LiClO₄, and LiN(SO₂F)₂, and lithium salts having a halogenated hydrocarbon group, such as LiSO₃CF₃, LiN(SO₂CF₃)₂, LiN(SO₂C₂F₅)₂, LiN(SO₂CF₃)(SO₂C₄F₉), LiC(SO₂CF₃)₃ and LiC(SO₂C₂F₅)₃. Among these, an inorganic lithium salt is preferable, and LiPF₆ is more preferable.

The content of the electrolyte salt in the nonaqueous electrolyte solution is preferably 0.1 mol/dm³ or more and 2.5 mol/dm³ or less, more preferably 0.3 mol/dm³ or more and 2.0 mol/dm³ or less, further preferably 0.5 mol/dm³ or more and 1.7 mol/dm³ or less, and particularly preferably 0.7 mol/dm³ or more and 1.5 mol/dm³ or less. The content of the electrolyte salt within the range mentioned above allows the ionic conductivity of the nonaqueous electrolyte to be increased.

The nonaqueous electrolyte may contain an additive. Examples of the additive include aromatic compounds such as biphenyl, alkylbiphenyl, terphenyl, partly hydrogenated terphenyl, cyclohexylbenzene, t-butylbenzene, t-amylbenzene, diphenyl ether, and dibenzofuran; partial halides of the aromatic compounds such as 2-fluorobiphenyl, o-cyclohexylfluorobenzene, and p-cyclohexylfluorobenzene; halogenated anisole compounds such as 2,4-difluoroanisole, 2,5-difluoroanisole, 2,6-difluoroanisole, and 3,5-difluoroanisole; succinic anhydride, glutaric anhydride, maleic anhydride, citraconic anhydride, glutaconic anhydride, itaconic anhydride, and cyclohexanedicarboxylic anhydride; ethylene sulfite, propylene sulfite, dimethyl sulfite, dimethyl sulfate, ethylene sulfate, sulfolane, dimethyl sulfone, diethyl sulfone, dimethylsulfoxide, diethyl sulfoxide, tetramethylene sulfoxide, diphenyl sulfide, 4,4′-bis(2,2-dioxo-1,3,2-dioxathiolane), 4-methylsulfonyloxymethyl-2,2-dioxo-1,3,2-dioxathiolane, thioanisole, diphenyl disulfide, dipyridinium disulfide, perfluorooctane, tristrimethylsilyl borate, tristrimethylsilyl phosphate, and tetrakistrimethylsilyl titanate. These additives may be used singly, or two or more thereof may be used in mixture.

The content of the additive contained in the nonaqueous electrolyte is preferably 0.01% by mass or more and 10% by mass or less, more preferably 0.1% by mass or more and 7% by mass or less, further preferably 0.2% by mass or more and 5% by mass or less, and particularly preferably 0.3% by mass or more and 3% by mass or less, with respect to the total nonaqueous electrolyte. When the content of the additive is within the above range, it is possible to improve capacity retention performance or charge-discharge cycle performance after high-temperature storage, and to further improve safety.

In the secondary battery (nonaqueous electrolyte energy storage device), the positive electrode potential at the end-of-charge voltage under normal usage is preferably 4.30 V vs. Li/Li⁺ or more, more preferably 4.35 V vs. Li/Li⁺ or more, and further preferably less than 4.40 V vs. Li/Li⁺ or more in some cases. The positive electrode potential at the end-of-charge voltage under normal usage is set to be equal to or more than the above lower limit, thereby allowing the discharge capacity to be increased, and allowing the energy density to be increased.

It is to be noted the term “under normal usage” means use of the nonaqueous electrolyte energy storage device while employing charge conditions recommended or specified for the nonaqueous electrolyte energy storage device. For example, when a charger for the nonaqueous electrolyte energy storage device is prepared, the term refers to a case of using the nonaqueous electrolyte energy storage device by applying the charger.

The upper limit of the positive electrode potential at the end-of-charge voltage under normal usage of the secondary battery is, for example, 5.0 V vs. Li/Li⁺, and may be 4.8 V vs. Li/Li⁺ or may be 4.7 V vs. Li/Li⁺.

In the nonaqueous electrolyte energy storage device, at least a part of the electrode assembly composed of the positive electrode, the negative electrode, and the separator is preferably pressurized. Such pressurization tends to increase the capacity retention ratio in repeated charge-discharge. For example, the electrode assembly housed in the case may be pressurized from the outside of the case, that is, via the case. The electrode assembly is preferably pressurized in the direction in which the positive electrode, the negative electrode, and the separator have overlaps with each other (thickness direction of each layer). More specifically, the positive active material layer and the negative active material layer are preferably pressurized in the direction of crushing the layers in the thickness direction. A part of the electrode assembly (for example, a pair of curved parts or the like of a flattened wound-type electrode assembly) may be, however, subjected to no pressurization. In addition, flat parts of a laminated electrode assembly and of a flattened wound-type electrode assembly may be only partially subjected to no pressurization. The pressure applied to at least a part of the above-mentioned electrode assembly pressurized or the pressure applied to the case from the outside is preferably 0.01 MPa or more and 2 MPa or less, more preferably 0.1 MPa or more and 1.5 MPa or less, still more preferably 0.2 MPa or more and 1 MPa or less. The pressure is set to be equal to or more than the above lower limit, thereby allowing the capacity retention ratio to be increased. In contrast, the pressure is set to be equal to or less than the above upper limit, thereby further suppressing any short circuit in repeated charge-discharge.

The electrode assembly can be pressurized by, for example, a pressurizing member that pressurizes the case from the outside. The pressurizing member may be a restraining member that restrains the shape of the case. The pressurizing member (restraining member) is provided so as to sandwich and then pressurize the electrode assembly from both surfaces in the thickness direction via the case, for example. The surfaces of the electrode assembly to be pressurized have contact with the inner surface of the case directly or with another member interposed therebetween. Thus, the electrode assembly is pressurized by pressurizing the case. Examples of the pressurizing member include a restraining band or a metallic frame. For example, a metallic frame may be configured to apply an adjustable load with a bolt or the like. In addition, a plurality of nonaqueous electrolyte energy storage devices may be arranged side by side in the thickness direction of the electrode assembly, and fixed with the use of a frame or the like with the plurality of nonaqueous electrolyte energy storage devices pressurized from both ends in the thickness direction.

Dendrites have a tendency to grow when the current density during charge is high. Accordingly, the nonaqueous electrolyte energy storage device according to one embodiment of the present invention can be suitably applied to an application in which charge with a high current density is performed. Examples of such an application include a power source for an automobile such as an electric vehicle (EV), a hybrid electric vehicle (HEV), or a plug-in hybrid electric vehicle (PHEV), a power source for a flying vehicle such as an airplane and a drone, and a power source for charge with regenerative electric power. In particular, the nonaqueous electrolyte energy storage device is particularly suitable as a power source for a flight vehicle, because the device has both an extremely high gravimetric energy density required particularly for a power source for a flight vehicle and adequate charge-discharge cycle performance.

The shape of the nonaqueous electrolyte energy storage device according to the present embodiment is not particularly limited, and examples thereof include cylindrical batteries, prismatic batteries, flat batteries, coin batteries and button batteries.

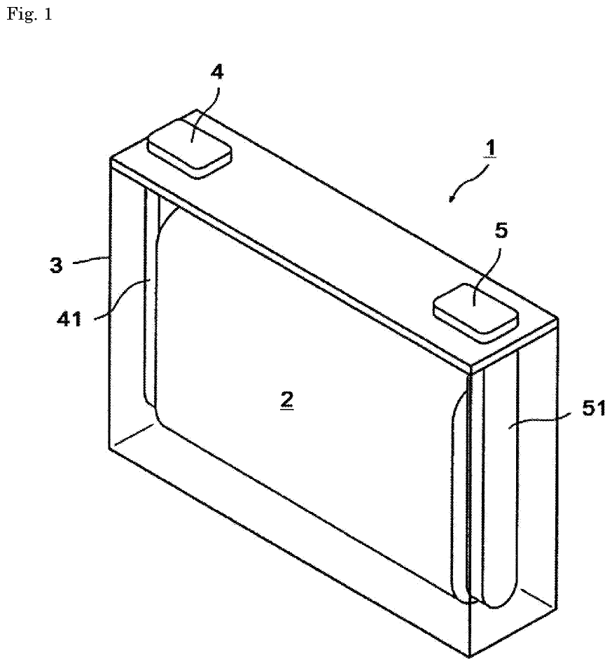

FIG. 1 shows a nonaqueous electrolyte energy storage device 1 as an example of a prismatic battery. FIG. 1 is a view showing an inside of a case in a perspective manner. An electrode assembly 2 having a positive electrode and a negative electrode which are wound with a separator interposed therebetween is housed in a prismatic case 3. The positive electrode is electrically connected to a positive electrode terminal 4 through a positive electrode lead 41. The negative electrode is electrically connected to a negative electrode terminal 5 via a negative electrode lead 51.

### Configuration of Nonaqueous Electrolyte Energy Storage Apparatus

The nonaqueous electrolyte energy storage device according to the present embodiment can be mounted as an energy storage unit (battery module) configured by assembling a plurality of nonaqueous electrolyte energy storage devices on a power source for automobiles such as electric vehicles (EV), hybrid vehicles (HEV), and plug-in hybrid vehicles (PHEV), a power source for flying vehicles such as airplanes and drones, a power source for electronic devices such as personal computers and communication terminals, or a power source for power storage, or the like. In this case, the technique according to one embodiment of the present invention may be applied to at least one nonaqueous electrolyte energy storage device included in the energy storage unit.

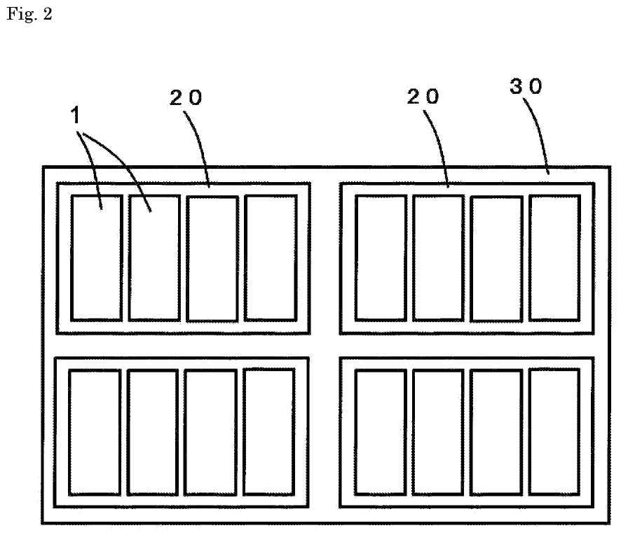

FIG. 2 shows an example of an energy storage apparatus 30 formed by assembling energy storage units 20 in each of which two or more electrically connected nonaqueous electrolyte energy storage devices 1 are assembled. The energy storage apparatus 30 may include a busbar (not illustrated) for electrically connecting two or more nonaqueous electrolyte energy storage devices 1 and a busbar (not illustrated) for electrically connecting two or more energy storage units 20. The energy storage unit 20 or the energy storage apparatus 30 may include a state monitor (not illustrated) that monitors the state of one or more nonaqueous electrolyte energy storage devices.

### Method for Manufacturing Nonaqueous Electrolyte Energy Storage Device

A method for manufacturing a nonaqueous electrolyte energy storage device according to an embodiment of the present invention includes: preparing a combination of a positive electrode with a negative electrode containing metal lithium or a negative electrode that has a surface region capable of precipitating metal lithium during charge; preparing a nonaqueous electrolyte including a fluorinated solvent; and preparing a separator with an air permeability resistance of 150 seconds or less.

Preparing the negative electrode containing metal lithium may be fabricating the negative electrode containing metal lithium. The negative electrode can be fabricated by laminating a negative active material layer containing metal lithium directly on a negative substrate or over the substrate with an intermediate layer interposed therebetween, and pressing or the like. The negative active material layer containing metal lithium may be a lithium foil or a lithium alloy foil. For a specific form of and a suitable form of the negative electrode to be prepared, the above-described form can be applied as the negative electrode provided in the nonaqueous electrolyte energy storage device.

The negative electrode that has a surface region capable of precipitating metal lithium during charge may be, for example, a negative electrode composed of only a negative substrate. In the case of preparing the negative electrode hat has a surface region capable of precipitating metal lithium during charge, a positive electrode including a positive active material containing lithium ions is prepared in advance for the positive electrode.

Preparing the nonaqueous electrolyte containing the fluorinated solvent may be preparing a nonaqueous electrolyte containing a fluorinated solvent. The nonaqueous electrolyte can be prepared by mixing respective components constituting the nonaqueous electrolyte, such as a fluorinated solvent and other components. For a specific form of and a suitable form of the nonaqueous electrolyte to be prepared, the above-described form can be applied as the nonaqueous electrolyte provided in the nonaqueous electrolyte energy storage device.

Preparing the separator with an air permeability resistance of 150 seconds or less may be preparing or purchasing a commercially available product of such a separator, or may be manufacturing such a separator. For a specific form of and a suitable form of the separator to be prepared, the above-described form can be applied as the separator provided in the nonaqueous electrolyte energy storage device.

The method for manufacturing the nonaqueous electrolyte energy storage device includes, for example, preparing or fabricating the positive electrode, preparing or fabricating a negative electrode, preparing or fabricating a nonaqueous electrolyte, preparing or fabricating the separator, forming an electrode assembly in which the positive electrode and the negative electrode are alternately superposed by stacking or winding the positive electrode and the negative electrode with a separator interposed between the electrodes, housing the positive electrode and the negative electrode (electrode assembly) in a case, and injecting the nonaqueous electrolyte into the case. The nonaqueous electrolyte energy storage device can be obtained by sealing an injection port after the injection.

### Other Embodiments

The present invention is not limited to the above embodiments, and various modifications may be made without departing from the gist of the present invention. For example, a configuration according to one embodiment can additionally be provided with a configuration according to another embodiment, or a configuration according to one embodiment can partially be replaced with a configuration according to another embodiment or a well-known technique. Furthermore, a part of the configuration according to one embodiment can be removed. In addition, a well-known technique can be added to the configuration according to one embodiment.

In the above embodiment, although the case where the nonaqueous electrolyte energy storage device is used as a nonaqueous electrolyte secondary battery (for example, lithium ion secondary battery) that can be charged and discharged has been described, the type, shape, size, capacity, and the like of the nonaqueous electrolyte energy storage device are arbitrary. The nonaqueous electrolyte energy storage device according to the present invention can also be applied to capacitors such as various nonaqueous electrolyte secondary batteries, electric double layer capacitors, and lithium ion capacitors.

### EXAMPLES

Hereinafter, the present invention will be described more specifically by way of examples, but the present invention is not limited to the following examples.

The separators used in examples and comparative examples are presented below. For each of the substrate resins, a resin produced by biaxial stretching was used.
separator A: Separator (without any heat-resistant layer) of 35 seconds in air permeability resistance and of 16 μm in average thickness, composed of a substrate layer with inorganic particles dispersed in a substrate resin (polyolefin-based resin), the content of the inorganic particles in the substrate layer: 50% by mass
separator B: Separator (without any heat-resistant layer) of 45 seconds in air permeability resistance and of 16 μm in average thickness, composed of a substrate layer with inorganic particles dispersed in a substrate resin (polyolefin-based resin), the content of the inorganic particles in the substrate layer: 25% by mass
separator C: Separator (without any heat-resistant layer) of 70 seconds in air permeability resistance and of 16 μm in average thickness, composed of a substrate layer with inorganic particles dispersed in a substrate resin (polyolefin-based resin), the content of the inorganic particles in the substrate layer: 15% by mass
separator D: Separator of 90 seconds in air permeability resistance and of 21 μm in average thickness, composed of: a substrate layer composed of only a substrate resin (polyolefin-based resin); and a heat-resistant layer
separator E: Separator of 172 seconds in air permeability resistance and of 17 μm in average thickness, composed of: a substrate layer composed of only a substrate resin (polyolefin-based resin); and a heat-resistant layer
separator F: Separator of 286 seconds in air permeability resistance and of 25 μm in average thickness, composed of a substrate layer composed of only a substrate resin (polyolefin-based resin)
separator G: Separator of 300 seconds in air permeability resistance and of 24 μm in average thickness, composed of: a substrate layer composed of only a substrate resin (polyolefin-based resin); and a heat-resistant layer

### Example 1

### Fabrication of Positive Electrode

As a positive active material, a lithium-transition metal composite oxide, which had an α-NaFeO₂-type crystal structure and was represented by Li_{1+α}Me_{1-α}O₂ (Me was a transition metal), was used. In this regard, the molar ratio Li/Me of Li to Me was 1.33, and Me was composed of Ni and Mn and was contained at a molar ratio of Ni:Mn=1:2.

A positive electrode paste, which contained the positive active material, acetylene black (AB) as a conductive agent, and polyvinylidene fluoride (PVDF) as a binder at a mass ratio of 94:4.5:1.5, was prepared using N-methylpyrrolidone (NMP) as a dispersion medium. The positive electrode paste was applied to one surface of an aluminum foil with an average thickness of 15 μm as a positive substrate, and dried, and the resultant was pressed and cut to fabricate a positive electrode having a positive active material layer disposed in a rectangular shape having a width of 30 mm and a length of 40 mm.

### Fabrication of Negative Electrode

On one surface of a copper foil of 10 μm in average thickness as a negative substrate, a lithium foil (metal lithium: 100% by mass) of 100 μm in average thickness was laminated as a negative active material layer, pressed, and then cut into a rectangular shape of 32 mm in width and 40 mm in length, thereby fabricating a negative electrode.

### Preparation of Nonaqueous Electrolyte

As a nonaqueous electrolyte, LiPF₆ was dissolved at a concentration of 1 mol/dm³ in a mixed solvent of fluoroethylene carbonate (FEC) and 2,2,2-trifluoroethylmethyl carbonate (TFEMC) mixed at a volume ratio of 30:70.

### Fabrication of Nonaqueous Electrolyte Energy Storage Device

An electrode assembly was produced by laminating the positive electrode and the negative electrode with the above-mentioned separator A interposed between the electrodes. The electrode assembly was housed in a case, then the nonaqueous electrolyte was injected into the inside of the case, and then an opening of the case was sealed to obtain a nonaqueous electrolyte energy storage device (secondary battery) with the case pressurized from the outsider at 0.3 MPa according to Example 1.

### EXAMPLES 2 TO 4 AND COMPARATIVE EXAMPLES 1 to 5

Nonaqueous electrolyte energy storage devices of Examples 2 to 4 and Comparative Examples 1 to 5 were obtained similarly to Example 1 except that the type of the separator and the composition of the nonaqueous solvent for the nonaqueous electrolyte were set as presented in Table 1. In the table, EC represents an ethylene carbonate, and EMC represents an ethyl methyl carbonate.

### Initial Charge-Discharge

The obtained respective nonaqueous electrolyte energy storage devices were subjected to the initial charge-discharge under the following conditions. At 25° C., constant current constant voltage charge was performed at a charge current of 0.1 C and an end-of-charge voltage of 4.60 V. With regard to the charge termination conditions, charge was performed until the charge current reached 0.02 C. Thereafter, a pause time of 10 minutes was provided. Thereafter, constant current discharge was performed at a discharge current of 0.1 C and an end-of-discharge voltage of 2.00 V, and then a pause time of 10 minutes was provided. This charge-discharge cycle was performed for 2 cycles.

### Charge-Discharge Cycle Test

Subsequently, the following charge-discharge cycle test was performed. At 25° C., constant current constant voltage charge was performed at a charge current of 1 C and an end-of-charge voltage of 4.60 V. With regard to the charge termination conditions, charge was performed until the charge current reached 0.05 C. Thereafter, a pause time of 10 minutes was provided. Thereafter, constant current discharge was performed at a discharge current of 1 C and an end-of-discharge voltage of 2.00 V, and then a pause time of 10 minutes was provided. This charge-discharge cycle was repeated, and the number of cycles was recorded until causing a short circuit. With the number of cycles until causing a short circuit in excess of 25, the discharge capacity retention ratio was determined. The discharge capacity retention ratio was regarded as the discharge capacity at the 25-th cycle with respect to the discharge capacity at the 5-th cycle. The results are shown in Table 1.

TABLE 1

| | Separator | | | | |
|---|---|---|---|---|---|
| | | Air | | Evaluation | |
| | | permeation | Nonaqueous solvent | The number of | |
| | | resistance | Composition | cycles until short | Discharge capacity |
| | Type | (second) | (volume ratio) | circuit | retention ratio (%) |
| Example 1 | A | 35 | FEC:TFEMC = 30:70 | 65 | 97 |
| Example 2 | B | 45 | FEC:TFEMC = 30:70 | 51 | 98 |
| Example 3 | C | 70 | FEC:TFEMC = 30:70 | 140 | 98 |
| Example 4 | D | 90 | FEC:TFEMC = 30:70 | 45 | 98 |
| Comparative | C | 70 | EC:EMC = 30:70 | 9 | — |
| Example 1 | | | | | |
| Comparative | E | 172 | FEC:TFEMC = 30:70 | 19 | — |
| Example 2 | | | | | |
| Comparative | F | 286 | FEC:TFEMC = 30:70 | 9 | — |
| Example 3 | | | | | |
| Comparative | G | 300 | FEC:TFEMC = 30:70 | 8 | — |
| Example 4 | | | | | |
| Comparative | F | 286 | EC:EMC = 30:70 | 5 | — |
| Example 5 | | | | | |

As shown in Table 1, in Comparative Examples 1 and 5 in which nonaqueous electrolytes including no fluorinated solvent were used, and Comparative Examples 2 to 5 in which separators in excess of 150 seconds in air permeability resistance were used, short circuits were caused with small numbers of cycles less than 20. In contrast, in the nonaqueous electrolyte energy storage devices according to Examples 1 to 4 obtained with the use of the nonaqueous electrolyte including the fluorinated solvent and the separator of 150 seconds or less in air permeability resistance, with the number of cycles until causing a short circuit in excess of 40, the short circuit was sufficiently suppressed, also with the result of the high discharge capacity retention ratio. In particular, as for the nonaqueous electrolyte energy storage device according to Example 3, as a result, the short circuit was particularly suppressed, probably because the air permeability resistance of the separator was particularly appropriate.

### INDUSTRIAL APPLICABILITY

The present invention can be applied to a nonaqueous electrolyte energy storage device used as a power source for electronic devices such as personal computers and communication terminals, automobiles, and the like.

### DESCRIPTION OF REFERENCE SIGNS

1: nonaqueous electrolyte energy storage device

2: electrode assembly

3: case

4: positive electrode terminal

41: positive electrode lead

5: negative electrode terminal

51: negative electrode lead

20: energy storage unit

30: energy storage apparatus

1. A nonaqueous electrolyte energy storage device comprising:
a negative electrode comprising metal lithium;
a nonaqueous electrolyte comprising a fluorinated solvent; and
a separator with an air permeability resistance of 150 seconds or less.

2. The nonaqueous electrolyte energy storage device according to claim 1, wherein the air permeability resistance is 50 seconds or more and 80 seconds or less.

3. The nonaqueous electrolyte energy storage device according to claim 1, wherein the separator comprises a substrate resin and inorganic particles dispersed in the substrate resin.

4. The nonaqueous electrolyte energy storage device according to claim 1, wherein a positive electrode potential at an end-of-charge voltage under normal usage is 4.30 V (vs. Li/Li⁺) or higher.

5. A method for manufacturing a nonaqueous electrolyte energy storage device, the method comprising:
preparing a combination of a positive electrode with a negative electrode comprising metal lithium or a negative electrode that has a surface region capable of precipitating metal lithium during charge;
preparing a nonaqueous electrolyte comprising a fluorinated solvent; and
preparing a separator with an air permeability resistance of 150 seconds or less.
